(19) United States
(12) Patent Application Publication
(10) Pub. No.: US 2006/0047388 A1
(43) Pub. Date: Mar. 2, 2006

(54) Lane deviation warning device of vehicle

(75) Inventors: Takuji Oka, Hiroshima (JP); Takeshi Murai, Hiroshima (JP)

Correspondence Address: NIXON PEABODY, LLP, 401 9TH STREET, NW, SUITE 900, WASHINGTON, DC, 20004-2128, US

(73) Assignee: Mazda Motor Corporation, Hiroshima (JP)

(21) Appl. No.: 11/168,563

(22) Filed: Jun. 29, 2005

(30) Foreign Application Priority Data
Sep. 1, 2004 (JP) 2004-254155

(51) Int. Cl. B62D 6/00

(52) U.S. Cl. 701/41; 701/300

(57) ABSTRACT

When it is determined by the lane deviation determining portion that the vehicle deviates from the lane and then it is determined by the critical condition determining portion that the vehicle will have the critical condition, the warning control portion operates the belt winder so as to wind up the seat belt and thereby apply the specified tension to the seat belt. Accordingly, the passenger is warned with the tension applied to the seat belt.

### BACKGROUND OF THE INVENTION

The present invention relates to a lane deviation warning device of a vehicle which warns a passenger when a traveling vehicle deviates from a lane.

Conventionally, this kind of lane deviation warning devices are well known. In these devices, a separation line (white line) of the traveling lane is detected by a camera picking up an image of the lane in front of the traveling vehicle, a position of the vehicle traveling with respect to the lane in a width direction is detected based on the detected separation line, and it is determined by the detected vehicle position with respect to the lane whether or not the vehicle deviates from the lane. When the vehicle's lane deviation is determined, the passenger is warned with a phone or vibrations of a seat or a front carpet (see, for example, Japanese Utility Model Laid-Open Publication No. 7-23651, Japanese Patent Laid-Open Publication No. 2001-341599).

However, the conventional devices just warn the passenger, and other countermeasures to the passenger who would not take any actions ignoring the warning are not taken basically. Namely, in a case, for example, where there exists a slope beside the traveling road, the vehicle would continue to travel on the slope and thereby there would be a risk of an occurrence of a vehicle rollover after the vehicle deviates from the lane. Or, in a case where another vehicle is parked at the side of the road, there would be a risk of a vehicle crash against the parked vehicle. Therefore, it is preferable that some proper actions should be taken in advance for those risks.

### SUMMARY OF THE INVENTION

The present invention has been devised in view of the above-described problem, and an object of the present invention is to provide a lane deviation warning device of a vehicle which can further improve the safety of the passenger in case of the vehicle lane deviation.

According to the present invention, there is provided a lane deviation warning device of a vehicle comprising a relative position detecting device operative to detect a position of the vehicle traveling on a road with respect to a lane in a width direction, a lane deviation determining device operative to determine whether or not the traveling vehicle deviates from the lane based on the relative position detected by the relative position detecting device, a warning device operative to warn a passenger when the lane deviation is determined by the lane deviation determining device, wherein the warning device comprises a belt winder operative to wind up a seat belt provided to the passenger to apply a specified tension to the seat belt and a control device operative to operate the belt winder when the lane deviation of the vehicle is determined by the lane deviation determining device, and the warning device warns the passenger by applying the specified tension to the seat belt of the passenger with the operation of the belt winder.

Accordingly, since the passenger is pressed against the seat back of the seat by the seat belt with the specified tension applied thereto, the passenger can notice an likelihood of the vehicle lane deviation easily and thereby the passenger can take any necessary actions promptly to avoid the vehicle lane deviation. Further, even if the passenger did not notice the likelihood of the vehicle lane deviation, the above-described belt winder can perform the function of applying the specified tension to the seat belt which is similar to a belt tensioner. Thereby, the passenger can be restrained in advance preparing for the vehicle overall, crash or the like, thereby improving the safety of the passenger.

According to a preferred embodiment of the present invention, there is further provided a critical condition determining device operative to determine in advance whether or not the vehicle will have a critical condition after the vehicle deviates from the lane when the lane deviation of the vehicle is determined by the lane deviation determining device, wherein the control device is constituted so as to operate the belt winder when it is determined by the critical condition determining device that the vehicle will have the critical condition, whereby the warning device warns the passenger by applying the specified tension to the seat belt when it is determined by the critical condition determining device that the vehicle will have the critical condition. Accordingly, since the belt winder is operated when it is determined by the critical condition determining device that the vehicle will have the critical condition, the passenger can be warned surely and properly by applying the specified tension to the seat belt when the critical condition of the vehicle is determined.

According to another preferred embodiment of the present invention, the above-described critical condition determining device is constituted so as to determine in advance whether or not the vehicle will have the critical condition, by determining whether a risk of an occurrence of a vehicle rollover after the vehicle deviates from the lane is high or not. Accordingly, the passenger can be properly restrained in advance especially preparing for the vehicle overall, thereby improving the safety of the passenger.

According to another preferred embodiment of the present invention, the above-described warning device is constituted so as to keep applying the specified tension to the seat belt until it is determined by the lane deviation determining device that the vehicle does not deviate from the lane. Accordingly, the safety of the passenger can be ensured surely.

According to another preferred embodiment of the present invention, there is provided an image pick-up device operative to pick up an image of the road in front of the vehicle, and the above-described critical condition determining device is constituted so as to determine in advance whether or not the vehicle will have the critical condition based on the picked-up image by the image pick-up device. Accordingly, since any configurations of the ground or any obstacles around the road in front of the traveling vehicle after the vehicle lane deviation are detected easily by dealing with the picked-up image by the pick-up device, the determination as to whether or not the vehicle will have the critical condition after the vehicle lane deviation can be made easily and surely.

According to another preferred embodiment of the present invention, the critical condition determining device is constituted so as to determine in advance whether or not the vehicle will have the critical condition based on the picked-up image by said image pick-up device which is an image around the road where the vehicle will travel after the lane deviation. Accordingly, for example, the likelihood of the vehicle rollover is determined based on the road image (such as ground configurations), and the determination as to whether or not the vehicle will have the critical condition can be made easily.

According to another preferred embodiment of the present invention, there is provided a vehicle speed detecting device operative to detect a vehicle traveling speed, and the critical condition determining device is constituted so as to determine in advance whether or not the vehicle will have the critical condition based on the picked-up image by the image pick-up device and the vehicle traveling speed by the vehicle speed detecting device. Accordingly, since the determination as to whether or not the vehicle will have the critical condition is made further considering the vehicle traveling speed, the determination can be made accurate.

Other features, aspects, and advantages of the present invention will become apparent from the following description which refers to the accompanying drawings.

### BRIEF DESCRIPTION OF THE DRAWINGS

FIG. 1 is a schematically perspective view illustrating an entire structure of a vehicle equipped with a lane deviation warning device of a vehicle according to an embodiment of the present invention.

FIG. 2 is an explanatory diagram illustrating a structure of a seat belt device.

FIG. 3 is block diagram illustrating a structure of the lane deviation warning device.

FIG. 4 is a flowchart of a control processing by a control unit.

FIG. 5 is a perspective view illustrating a scene where there exists a slope beside a traveling road which rises slant from the road surface.

### DETAILED DESCRIPTION OF THE INVENTION

Hereinafter, preferred embodiments of the present invention will be described referring to the accompanying drawings. It should be understood that even though embodiments are separately described, single features thereof may be combined to additional embodiments.

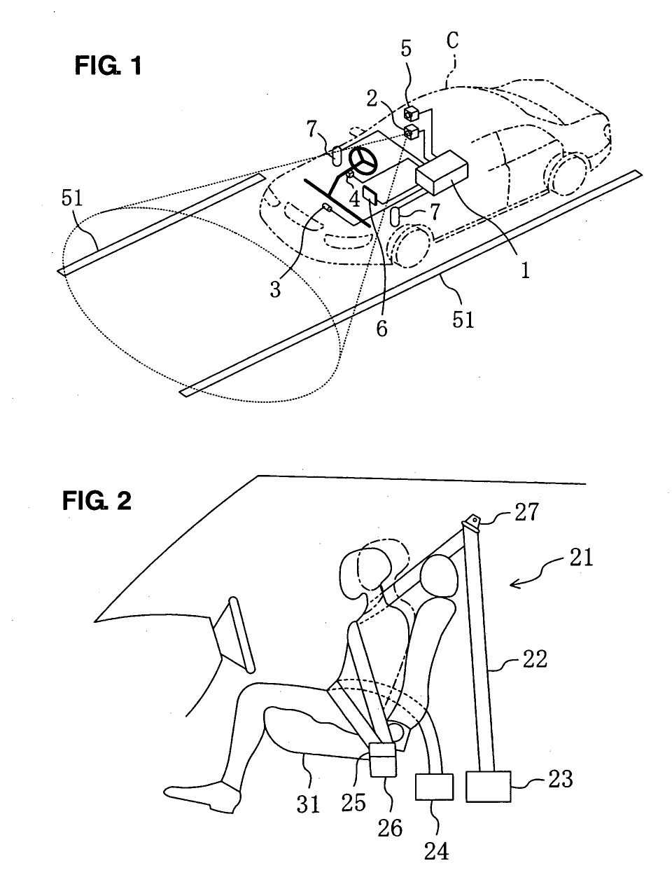

FIG. 1 illustrates the entire structure of a vehicle C (automotive vehicle) equipped with a lane deviation warning device according to an embodiment of the present invention. A reference numeral 1 denotes a control unit to control the lane deviation warning device. A reference numeral 2 denotes a first CCD camera to pick up an image of a lane in front of the traveling vehicle C. A reference numeral 3 denotes a vehicle speed sensor as a vehicle speed detecting device. A reference numeral 4 denotes a steering angle sensor as a steering angle detecting device to detect a steering angle of a steering wheel operated by a passenger (driver). A reference numeral 5 denotes a second CCD camera as an image pick-up device to pick up an image of the road (front and both sides of the road) in front of the vehicle. These first CCD camera 2, vehicle speed sensor 3, steering angle sensor 4 and second CCD camera 5 are coupled to the control unit 1 so as to output respective detecting information to the control unit 1. Herein, the function of the above-described second CCD camera may be performed by the first CCD camera, resulting in a single CCD camera. Meanwhile, the second CCD camera may be composed of two cameras, each of which picks up an image of front and one side of the road.

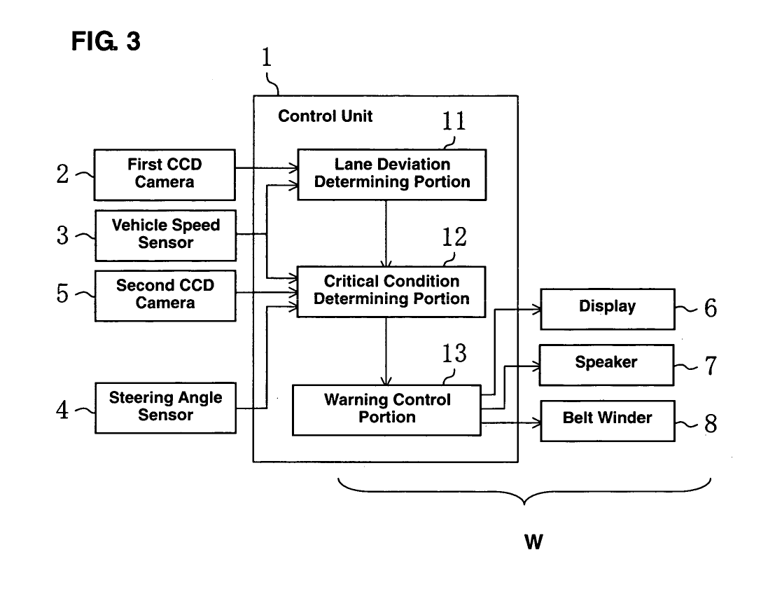

Also, in FIG. 1, a reference numeral 6 denotes a display to warn the passenger of the lane deviation of the vehicle, and a reference numeral 7 denotes a speaker to warn the passenger of the vehicle lane deviation by a sound. These display 6 and speaker 7 are coupled to the control unit 1, and a control operation described below is executed by a warning control device 13 (see FIG. 3), which will be described below, of the control unit 1.

FIG. 2 illustrates a seat belt device 21 installed into the vehicle C. The seat belt device 21 is provided to the passenger (driver) in a driver's seat 31, and a similar seat belt device to this is also provided to any other passengers in an assistant seat and other seats.

The seat belt device 21 is a three-point type of seat belt, which comprises a retractor 23 which winds up a seat belt 22, a lap anchor 24 to which a tip of the seat belt 22 drawn from the retractor 23 is attached, and a buckle 26 with which a tongue 25 provided at a middle portion of the seat belt 22 is detachably engaged. The buckle 26 is fixed to a vehicle body inside the seat 31, and the retractor 23 and lap anchor 24 are fixed to a vehicle body outside the seat 31.

The seat belt 22 drawn from the retractor 23 is guided by a slip guide 27 which is provided at an outside and top portion of the seat 31 so as to change its drawing direction from upward to downward. Then, its end tip is fixed to the lap anchor 24. The tongue 25 is provided between the slip guide 27 and the lap anchor 24 so as to slide on the seat belt 22, and the seat belt 22 is provided for the passenger by engaging the tongue 25 with the buckle 26.

There is provided at the retractor 23 a belt winder 8 (see FIG. 8) which winds up part of the seat belt 22 at the passenger and thereby can apply a specified tension (a tension to enable a driving operation and restrain the passenger properly) to the seat belt 22, which is not illustrated in FIG. 2. The belt winder 8 has a structure which is similar to the well-known electric pretensioner to apply the tension to the seat belt 22 before the crash of the vehicle C. This belt winder 8 is so controlled by the control unit 1 as described below that it can warn the passenger with the seat belt 22 of the vehicle lane deviation.

As illustrated in FIG. 3, the image data picked up by the first CCD camera 2 and the vehicle speed data detected by the vehicle speed sensor 3 are inputted to a lane deviation determining portion 11 of the control unit 1. The lane deviation determining portion 11 determines whether or not the traveling vehicle C deviates from the lane based on the data of image and vehicle speed. Namely, a frontward-watching distance L is calculated according to the vehicle speed detected by the vehicle speed sensor 3. A partition line of the traveling lane (for example, a white line 51 in FIG. 1) is detected through the general processing of the picked-up image by the first CCD camera 2. Then, a lateral position deviation dy0 (namely, a lateral position of the vehicle C with respect to the traveling lane) of the center line of the vehicle C with respect to the target traveling path in the width direction (herein, a center line of the traveling lane) which is obtained based on the detected partition line, an angle between the traveling direction of the vehicle C and the traveling lane, and the width of the lane are detected respectively. Thus, the first CCD camera 2 constitutes a relative position detecting device to detect the relative position of the vehicle traveling on the road with respect to the lane in the width direction. And, a prediction value dy1 (hereinafter, referred to as “future lateral position”) of the lateral position deviation at the frontward-watching distance L is calculated based on the above-described target traveling path, lateral position deviation dy0 and angle between the traveling direction of the vehicle C and the traveling lane (since this calculation is generally known, its detailed description is omitted here). When the calculated future lateral position dy1 is greater than a threshold D (the threshold D has a greater value as the lane width becomes wide) for the lane deviation determination, it is determined that the traveling vehicle C deviates from the lane (namely, the lane deviation is predicted). Meanwhile, when the calculated future lateral position dy1 is smaller than the threshold D, it is determined that the traveling vehicle C does not deviate from the lane. Thus, the lane deviation determining portion 11 constitutes a lane deviation determining device operative to determine where or not the traveling vehicle C deviates from the lane based on the relative position detected by the relative position detecting device.

When it is determined by the lane deviation determining portion 11 that the vehicle C deviates from the lane (the lane deviation is predicted), a critical condition determining portion 12 determines in advance whether or not the vehicle C will have a critical condition after the vehicle lane deviation. Namely, the vehicle speed data detected by the vehicle speed sensor 3, steering angle data detected by the steering angle sensor 4, and image date picked up by the second CCD camera 5 are inputted to the critical condition determining portion 12. The critical condition determining portion 12 determines based on these data whether or not the vehicle C will have the critical condition after the vehicle lane deviation. Thus, the critical condition determining portion 12 constitutes a critical condition determining device operative to determine whether or not the vehicle C will have the critical condition after the vehicle lane deviation.

The critical condition determination by the critical condition determining portion 12 will be described more in detail. The critical condition determining portion 12 determines based on the above-described inputted data whether a risk of an occurrence of a vehicle rollover after the vehicle C deviates from the lane is high or not, or whether a risk of an occurrence of a vehicle crash against an obstacle after the vehicle C deviates from the lane is high or not. The determination as to whether or not the vehicle C will have the critical condition is made based on results of the above-described determination. Namely, when it is determined that risks of the vehicle rollover or the vehicle crash are high, it is determined that the vehicle C will have the critical condition.

The determination as to whether the risks of the vehicle rollover or the vehicle crash are high or not is made, for example, in the following manner. Namely, it is determined based on the image data picket up by the second CCD camera 5 as to how a configuration of the ground where the traveling vehicle C will travel after the vehicle lane deviation is. For example, if it is determined that the ground configuration predicted is that there exists a slope 41 beside the traveling road which rises slant from the road surface as illustrated in FIG. 5, it is determined that the vehicle C would continue to travel on the slope and thereby there would be a high risk of the vehicle rollover. Herein, it is preferable that this high risk of the vehicle rollover is determined in case that the vehicle speed detected by the vehicle speed sensor 3 (or, the vehicle speed at the time the vehicle deviates from the lane) is higher than a specified speed. Further, an angle (hereinafter, referred to as “a lane deviation angle”) between the traveling direction of the vehicle C and the traveling lane at the time the vehicle C deviates from the lane may be obtained, considering the steering angle. And, the high risk of the vehicle rollover may be determined in case that the lane deviation angle and the vehicle speed are greater than respective specified values.

Also, if it is determined based on the image data picket up by the second CCD camera 5 that there exists an obstacle, such as a tunnel wall or another vehicle, where the traveling vehicle C will travel after the vehicle lane deviation, it is determined that there would be a high risk of the vehicle crash against such obstacles. Herein, an existence information of the tunnel wall may be obtained according to the navigation system or the like. And, an existence information of another vehicle may be obtained according to the scanning radar device or the like.

Further, if it is determined based on the image data picket up by the second CCD camera 5 that there exists a guide rail where the traveling vehicle C will travel after the vehicle lane deviation, it is not determined that there would be a high risk of the vehicle rollover even though the slope 41 exits there. However, in case that the above-described lane deviation angle and the vehicle speed are greater than respective specified values, it is determined that a risk of the vehicle crash against the guard rail is high.

When it is determined by the critical condition determining portion 12 that the vehicle C will have the critical condition, a warning control portion 13 operates the belt winder 8. Thus, the belt winder 8 applies the specified tension to the seat belt 22, thereby warning the passenger of the vehicle lane deviation. Herein, the applying of the specified tension to the seat belt 22 is kept until it is determined by the lane deviation determining portion 11 that the vehicle does not deviate from the lane.

Meanwhile, when it is determined that the vehicle C will not have the critical condition, the warning control portion 13 operates the display 6 and the speaker 7, and thereby the display warning and the sound warning are performed. Namely, according to the present embodiment, when the vehicle is not in so critical condition, the critical condition determining portion 12 further determines whether the critical condition is in a middle level or a low level. When it is determined that the critical condition is in the low level (for example, when the vehicle speed is lower than a standard speed), the display warning with the display 6 is performed by the warning control portion 13. Meanwhile, when it is determined that the critical condition is in the middle level (for example, when the vehicle speed is higher than the standard speed), the sound warning with the speaker 7 is performed by the warning control portion 13. Thus, these display 6, speaker 7, belt winder 8 and warding control portion 13 constitute a warning device W which warns the passenger when the lane deviation is determined by the lane deviation determining device.

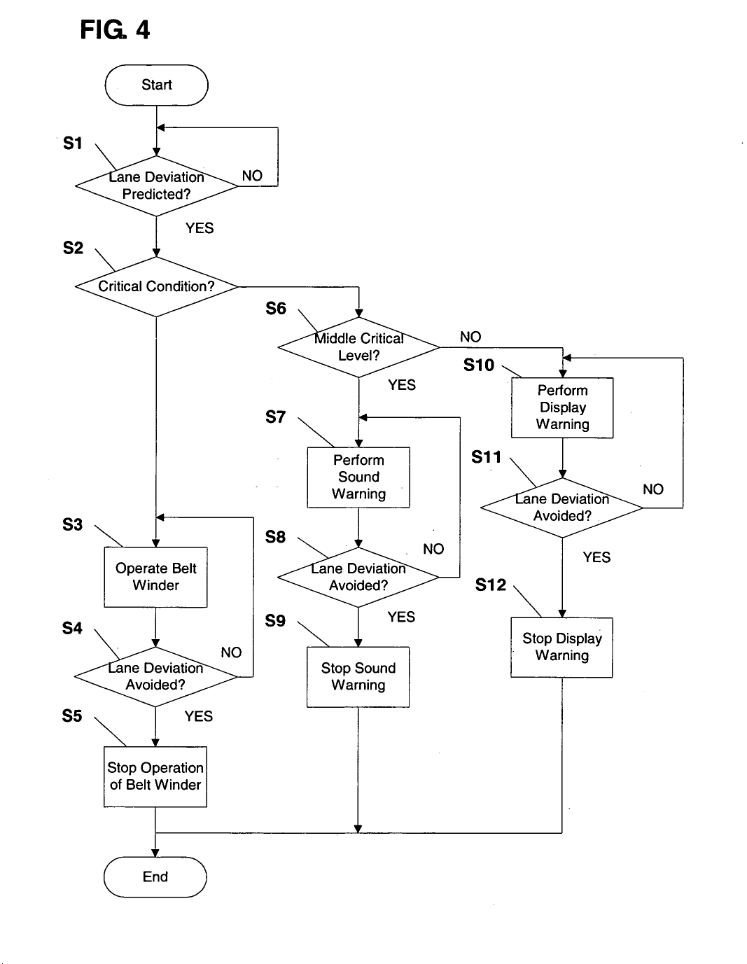

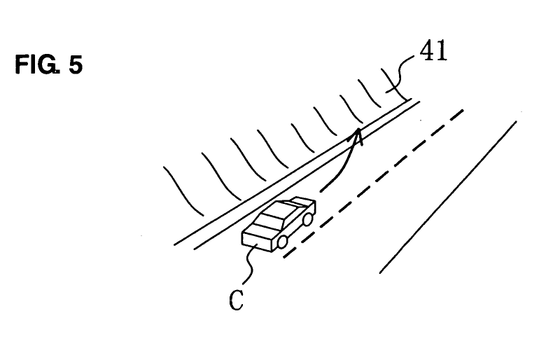

Hereinafter, the control processing of the control unit 1 will be described referring to a flowchart of FIG. 4.

At first, in step S1, it is determined by the lane deviation determining portion 11 whether or not the vehicle C deviates from the lane (whether or not the vehicle lane deviation is predicted). When the answer to the step S1 is NO, the control sequence returns to the step S1. When the answer to step S1 is YES, the control sequence proceeds to step S2.

In the step S2, it is determined by the critical condition determining portion 12 whether or not the vehicle C will have the critical condition after the vehicle lane deviation. When the answer to the step S2 is YES, the control sequence proceeds to step S3. When the answer to the step S2 is NO (when the critical condition is in the middle or low levels), the control sequence proceeds to step S6.

In the step S3, the warning control portion 13 warns the passenger with the belt winder 8. Namely, the belt winder 8 is operated and the specified tension is applied to the seat belt 22 provided to the passenger. Then, in step S4, it is determined whether or not the vehicle lane deviation is avoided, i.e., whether or not the lane deviation determining portion 11 determines that the vehicle does not deviate from the lane. When the answer to the step S4 is NO, the control sequence retunes to the step S3. When the answer to the step S4 is YES, the control sequence proceeds to step S5, where the operation of the belt winder 8 is stopped and the control ends.

In the step S6, it is determined by the critical condition determining portion 12 whether or not the critical condition of the vehicle C is in the middle level. When the answer to the step S6 is YES, the control sequence proceeds to step S7, where the sound warning with the speaker 7 is performed by the warning control portion 13. Next, in step S8, the determination as to whether the lane deviation is avoided or not is made. When the answer to the step S8 is NO, the control sequence returns to the step S7. When the answer to the step S8 is YES, the control sequence proceeds to step S9, where the operation of the sound warning is stopped and the control ends.

Meanwhile, when the answer to the step S6 is NO (the critical condition is in the middle level), the control sequence proceeds to step S10, where the display warning with the display 6 is performed by the warning control portion 13. Next, in step S11, the determination as to whether the lane deviation is avoided or not is made. When the answer to the step S11 is NO, the control sequence returns to the step S10. When the answer to the step S11 is YES, the control sequence proceeds to step S12, where the operation of the display warning is stopped and the control ends.

Thus, when it is determined by the control operation of the control unit 1 that the vehicle C deviates from the running lane, it is determined whether or not the vehicle C will have the critical condition after the vehicle lane deviation. When the determination that the vehicle C will have the critical condition is made, the belt winder 8 is operated and the specified tension is applied to the seat belt 22. Thereby, the passenger of the vehicle C is pressed against the seat back of the seat 31, as illustrated by a dash-dotted line in FIG. 2. Accordingly, since a pressing stimulation is directly applied to the passenger, the passenger can notice the likelihood of the vehicle lane deviation easily and thereby the passenger can take some necessary actions promptly to avoid the vehicle lane deviation. Further, even if the passenger did not notice the likelihood of the vehicle lane deviation, the passenger can be restrained by the seat belt properly in advance preparing for the vehicle crash or the vehicle, thereby improving the safety of the passenger.

When the critical condition is in the middle level or the low level, the sound warning or the display warning are performed. Accordingly, the passenger can be warned properly according to the level of the vehicle critical condition.

Herein, although the belt winder 8 is operated to apply the specified tension to the seat belt 22 when it is determined by the critical condition determining portion 12 that the vehicle C will have the critical condition in the above-described embodiment, the belt winder 8 may be operated when it is determined that the vehicle C deviates from the lane. Namely, when it is determined by the lane deviation determining portion 11 that the vehicle C deviates from the lane, the warning control portion 13 warns the passenger with the operation of the belt winder 8. Thus, whenever the vehicle lane deviation is determined, the specified tension is applied to the seat belt 22 and thereby the vehicle lane deviation warning is performed. Accordingly, the safety of the passenger can be ensured surely. Also, in case that the second CCD camera 5 for the critical condition determining portion 12 is omitted, there can be provided the critical condition determining portion 12 with reduced costs.

Also, whenever the lane deviation warning with the belt winder 8 is performed, the display and sound warning may be constituted so as to be performed.

The present invention should not be limited to the above-described embodiments and modified characteristics, but any other modifications and improvements may be applied within the scope of a sprit of the present invention.

What is claimed is:

1. A lane deviation warning device of a vehicle, comprising:
a relative position detecting device operative to detect a position of the vehicle traveling on a road with respect to a lane in a width direction;
a lane deviation determining device operative to determine whether or not the traveling vehicle deviates from the lane based on the relative position detected by said relative position detecting device;
a warning device operative to warn a passenger when the lane deviation is determined by said lane deviation determining device,
wherein said warning device comprises a belt winder operative to wind up a seat belt provided to the passenger to apply a specified tension to the seat belt and a control device operative to operate said belt winder when the lane deviation of the vehicle is determined by said lane deviation determining device, and said warning device warns the passenger by applying the specified tension to the seat belt of the passenger with the operation of said belt winder.

2. The lane deviation warning device of a vehicle of claim 1, further comprising a critical condition determining device operative to determine in advance whether or not the vehicle will have a critical condition after the vehicle deviates from the lane when the lane deviation of the vehicle is determined by said lane deviation determining device,
wherein said control device is constituted so as to operate said belt winder when it is determined by said critical condition determining device that the vehicle will have the critical condition, whereby said warning device warns the passenger by applying the specified tension to the seat belt when it is determined by said critical condition determining device that the vehicle will have the critical condition.

3. The lane deviation warning device of a vehicle of claim 2, wherein said critical condition determining device is constituted so as to determine in advance whether or not the vehicle will have the critical condition, by determining whether a risk of an occurrence of a vehicle rollover after the vehicle deviates from the lane is high or not.

4. The lane deviation warning device of a vehicle of claim 2, wherein said warning device is constituted so as to keep applying the specified tension to the seat belt until it is determined by said lane deviation determining device that the vehicle does not deviate from the lane.

5. The lane deviation warning device of a vehicle of claim 2, wherein there is provided an image pick-up device operative to pick up an image of the road in front of the vehicle, and said critical condition determining device is constituted so as to determine in advance whether or not the vehicle will have the critical condition based on the picked-up image by said image pick-up device.

6. The lane deviation warning device of a vehicle of claim 5, wherein said critical condition determining device is constituted so as to determine in advance whether or not the vehicle will have the critical condition based on the picked-up image by said image pick-up device which is an image around the road where the vehicle will travel after the lane deviation.

7. The lane deviation warning device of a vehicle of claim 5, wherein there is provided a vehicle speed detecting device operative to detect a vehicle traveling speed, and said critical condition determining device is constituted so as to determine in advance whether or not the vehicle will have the critical condition based on the picked-up image by said image pick-up device and the vehicle traveling speed by said vehicle speed detecting device.
